(19) United States
(12) Patent Application Publication
(10) Pub. No.: US 2017/0298309 A1
(43) Pub. Date: Oct. 19, 2017

(54) WET HOP COMPOSITION

(71) Applicant: Lagunitas Brewing Co., Petaluma, CA (US)

(72) Inventors: Michael Eric Beehler, Cotati, CA (US); Erron Stuart Dykins, Rohnert Park, CA (US); Jeremy Daniel Marshall, Bodega Bay, CA (US); Ashok Kumar Notaney, San Francisco, CA (US)

(21) Appl. No.: 15/130,662

(22) Filed: Apr. 15, 2016

(51) Int. Cl. C12C 3/00; C12C 11/00

(52) U.S. Cl. CPC C12C 3/00; C12C 11/00

(57) ABSTRACT

A hop composition can be prepared by admixing wet hops and deaerated water, wherein the water of the hop composition contains less than 500 ppb dissolved oxygen. The resulting hop composition preferably contains 1-30 wt % wet hops and 70-99 wt % added water, wherein the water of the hop composition contains less than 500 ppb dissolved oxygen. A finished beer can be prepared from a hop composition of the invention. Optionally, the hop composition can be frozen before use in preparing a finished beer.

### FIELD OF THE INVENTION

The invention relates to water-hop compositions and their use in brewing beer.

### BACKGROUND OF THE INVENTION

Brewing is a process for making beer by fermenting grain in water with yeast. Hops, which are the female flowers of the hop plant, are commonly extracted into the beer to add flavor and bitterness, for example. The lupulin gland is generally considered to be the most important part of the hop that is added to beer.

Hops are typically added to beer either as wet hops or dry hops. Wet hops, which are highly perishable, are generally harvested then added to beer within a few days. Storing wet hops for more than a few days causes a loss of flavor and/or aroma and attack by mold leading to rapid spoilage.

Dried hops, which is prepared by removing water from wet hops, can be stored for longer periods of time before adding to beer. In a typical process, the hops are heated in a kiln at temperatures from 125-160° F., causing the water content to go from 70-80% moisture off the vine to about 8-12% moisture, whereupon they are arranged in piles to allow moisture to equalize and then are pressed into about 200 pound bales that are then refrigerated, stored and/or transported for either sale or further processing. A beer prepared from dry hops, however, suffers from a reduction in flavor and/or aroma that is lost throughout the kilning, equalization and storage processes.

Freezing and thawing wet hops for later use results in rupturing of lupulin glands which then rapidly react with oxygen in the air which then negatively affects flavor and/or aroma. It also results in a gooey composition (similar to frozen and thawed leaf lettuce) that is undesirable and therefore difficult to process or use in the brewing process.

In one report, freeze dried hops was reported to have superior analytical properties to kiln dried hops (Algazzali, et. al. “A Comparison of Quality: Freeze dried Vs. Kiln dried Cascade Hops,” 2015 ASBC Annual Meeting, p. 62). However, commercial freeze drying of aroma hops is not economically viable and standard kilning infrastructure exists at every major hop farm. Although wet hops produce the best flavor and/or aroma, hop cones can be somewhat cumbersome to use and can block pipes within brewing, fermentation and/or filtration equipment commonly used in large scale production of beer.

Thus, there is a need for hop compositions that can be processed easily and/or stored for extended periods of time, while retaining desirable flavors and/or aroma.

### SUMMARY OF THE INVENTION

A hop composition can be prepared by admixing wet hops and deaerated water, wherein the water of the hop composition contains less than 500 ppb dissolved oxygen. The resulting hop composition preferably contains 1-30 wt % wet hops and 70-99 wt % added water, wherein the water of the hop composition contains less than 500 ppb dissolved oxygen.

A finished beer can be prepared from a hop composition of the invention. Optionally, the hop composition can be frozen before use in preparing a finished beer.

### BRIEF DESCRIPTION OF THE DRAWINGS

FIG. 1 is a schematic drawing of an operator using a vertical blender to generate a hop composition.

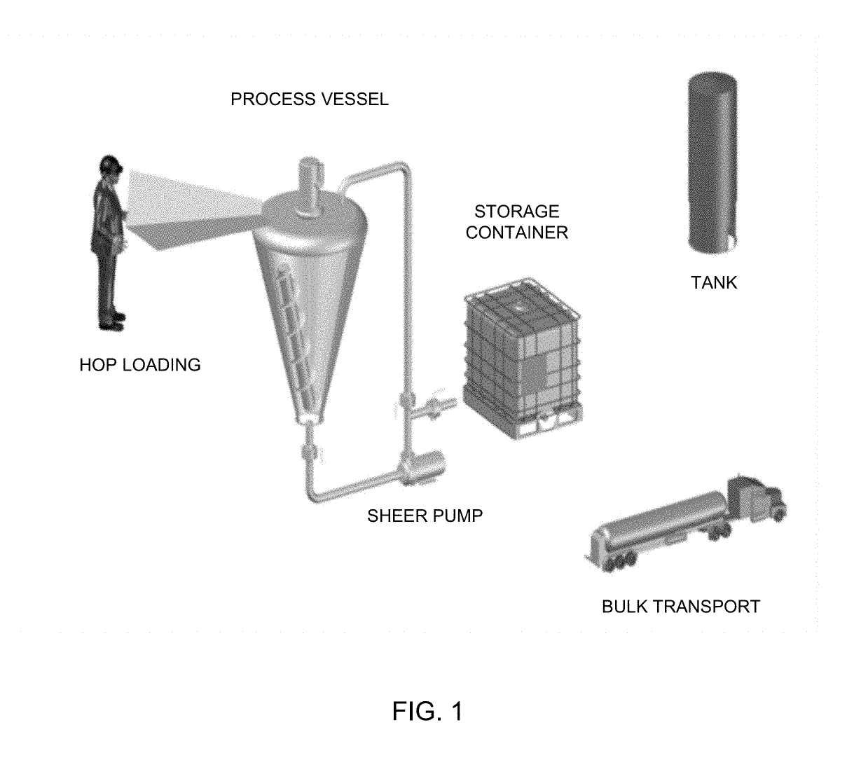

FIG. 2 compares the extraction rate of a standard wet whole hops composition versus a wet hops composition made according to Example 1.

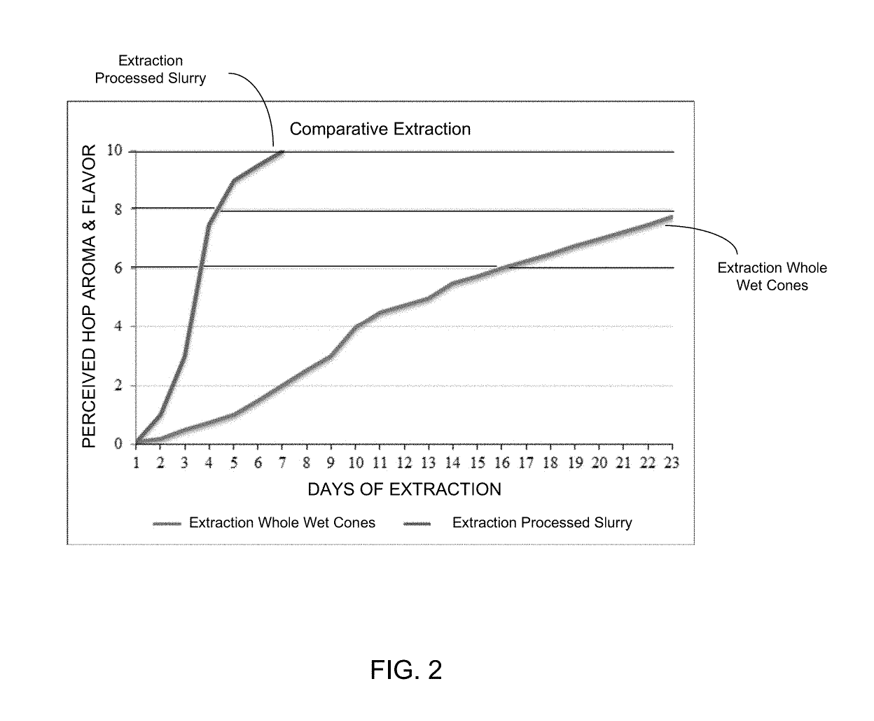

FIG. 3 reflects the relative flavor differences between wet- and dry-hopped beer.

FIG. 4 shows oxygen levels during oxygen removal (by vacuum) from a vertical blender.

### DETAILED DESCRIPTION OF THE INVENTION

As used herein, “wet hops” means hops that have not been dried and contain their natural moisture content (typically about 70-80% water). The term also includes hops that are naturally lower in water content, that have been partially dried, or that have been allowed to lose some moisture content. It is generally most convenient to use harvested hops in their natural state. The term “wet hops” is meant to exclude “dry hops”, as that term is used by those skilled in the art, which generally refers to hops that have been dried to moisture content of less than 20%.

“Deaerated water” means water that is substantially free of oxygen. Commercially available food-grade deaerated water typically contains less than 11 parts per billion (ppb) oxygen and can be as low as zero ppb.

In one embodiment, loosely packed bins of freshly picked wet hops are delivered to a conical vertical blender that is purged with inert gas and placed under a full vacuum until all oxygen is removed. Deaerated water is mixed with the wet hops and the entire contents are pumped through a positive displacement pump into two twin shear pumps which is recirculated until all contents are of the desired consistency. The resulting de-oxygenated slurry can either be used immediately for brewing or placed into oxygen purged totes for frozen storage which can be later thawed and used for brewing in the absence of a hop harvest.

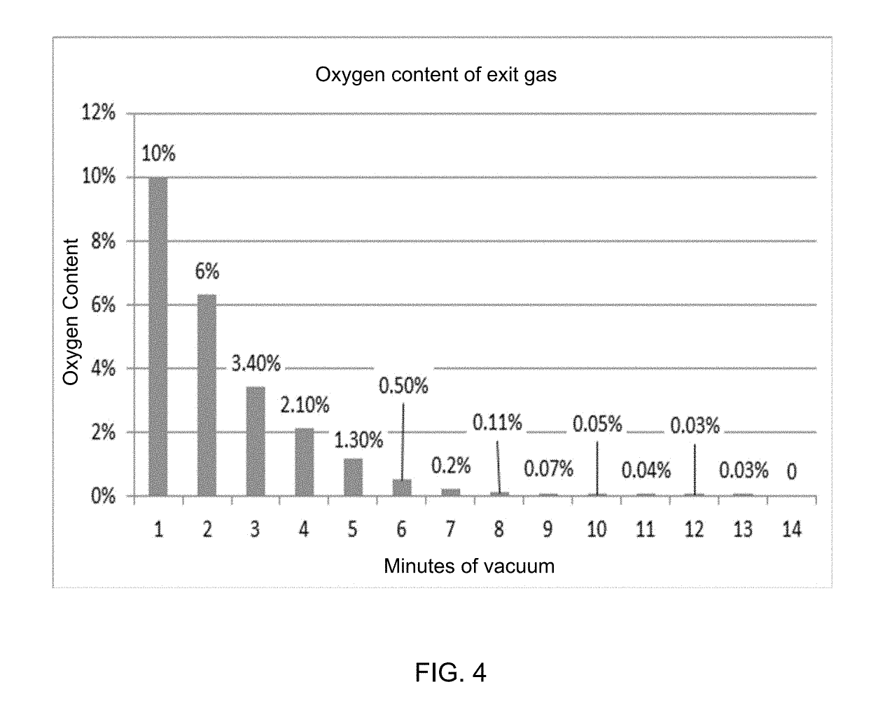

Preferably, the slurry is amenable to all existing brewery equipment and practices and therefore easy to remove from fermentation tanks and promotes bright beer at large yields compared to un-processed whole wet hop cones. Use of a vacuum achieves significantly faster oxygen removal from the wet whole hops, relative to a method of purging only with an inert gas. Purging with an inert gas can take up to 24 hours to achieve the same oxygen levels (e.g., 0.05%) in the exit gas. The time to remove oxygen (down to below 0.05%) using vacuum method is shown in FIG. 4.

In a preferred embodiment, a hop composition comprises 1-30 wt % wet hops, 70-99 wt % additional water and less than 500 ppb dissolved oxygen. The hop composition optionally contains additional dissolved or undissolved solids, liquids or gases. For example, pH-adjusting agents can be added. The total solids content of the composition is preferably about 15-25%. A higher solids content reduces flow and makes processing more difficult. A lower solids content requires a higher volume of the composition, which can result in inefficiencies of production and increase dilution of beer made therefrom. The optimal solid content may vary depending on the hop varietal used.

The amount of wet hops in the hop composition is preferably about 1-30, about 5-25, about 10-25, about 15-25, about 18-23, about 19-22 or about 20 wt % of the composition.

The amount of dissolved oxygen in the hop composition is preferably less than 500 ppb, less than 300 ppb, less than 100 ppb, less than 50 ppb, less than 20 ppb, less than 10 ppb, or less than 5 ppb dissolved oxygen.

The average particle size of the hops is preferably less than ¼ inch, more preferably between 5 nm and 5 mm. Smaller particle size is generally preferred because processing is generally easier and/or extraction is generally faster.

In a preferred embodiment, a hop composition is prepared by admixing ingredients comprising wet hops and deaerated water containing less than 500 ppb dissolved oxygen. Preferably, the composition is mixed in a vessel under a partial or complete vacuum. For example, the pressure in the vessel during mixing may be between 0 and 15 psi, preferably under anaerobic conditions, such as by purging the air from the vessel followed by the addition of an inert gas, such as carbon dioxide. After mixing, the composition may be further processed and/or stored under anaerobic conditions. Preferably, carbon dioxide is added to the vessel to a pressure of about 4-5 psi. The carbon dioxide is preferably beverage-grade, which is typically at least 99.9% pure.

Mixing the hop composition is preferably done in a way that allows hops to flow into the mixer(s) (wet hops have a tendency to form a mat and not flow), such as by hand, with a bladder or using an auger. In preferred embodiments, rupturing of lupulin glands during the mixing is not a concern as the lack of oxygen minimizes oxidation. A vertical blender, especially one with a swing arm, is preferred. Hop cones tend to float in aqueous solution and therefore an augering or screw-like mechanism is preferred in order to feed the hops downward and into, for example, outlet piping and shear pumps.

Preferably, the average particle size of the hops in the mixed composition is reduced, which generally makes processing easier and/or makes it easier to extract the flavor components. Methods for reducing particle size are known in the art and include shear pumps and colloid mills.

Preferably, the wet hops are purified before entering the mixing/shearing process described above. The removal of solid impurities—such as twigs, rocks, twine, segments of bine, etc.—is particularly preferred. Usually, it is most convenient to remove solid impurities from the hops after harvesting but before mixing with water. Methods for removing solid or non-solid impurities are well known in the art. Solid impurities can be removed, for example, by manual, mechanical or optical sorting. Preferably, the processed hop product is 100% pure.

After a hop composition embodiment of the invention is prepared, it can be used to make a palatable finished beer. For example, it can be mixed with fermented beer or fermenting wort to extract the flavors and/or aromas of the hops into the beer. Extraction occurs while beer is in contact with the lupulin particles from hops.

In preferred embodiments the hop flavors can be extracted in as little as 1, 2, 3 or 4 days. In contrast, whole wet hops generally take longer to be extracted, such as one to three weeks.

In preferred embodiments the yield of finished beer is greater than 60%, greater than 70%, greater than 80%, greater than 90%, about 90%, about 95%, about 98%, or about 99%. Yield=volume of finished beer/(volume of brewed wort+volume of added slurry). The yields are less than 100% because hops absorb beer which is “lost” when spent hops are separated from beer during separation/filtration. A typical yield of beer made with conventional wet hops is 50-60%. In contrast, in preferred embodiments of the invention, yields of up to 95% were achieved. See Table 1.

TABLE 1
Sample yields from wet hopped beers
using standard and slurry methods

| Batch | Wet hop method used | Yield |
|---|---|---|
| 1 | Standard (whole hops) | 59% |
| 2 | Standard (whole hops) | 62% |
| 3 | Standard (whole hops) | 58% |
| 4 | Slurry method of invention | 89% |
| 5 | Slurry method of invention | 88% |
| 6 | Slurry method of invention | 95% |

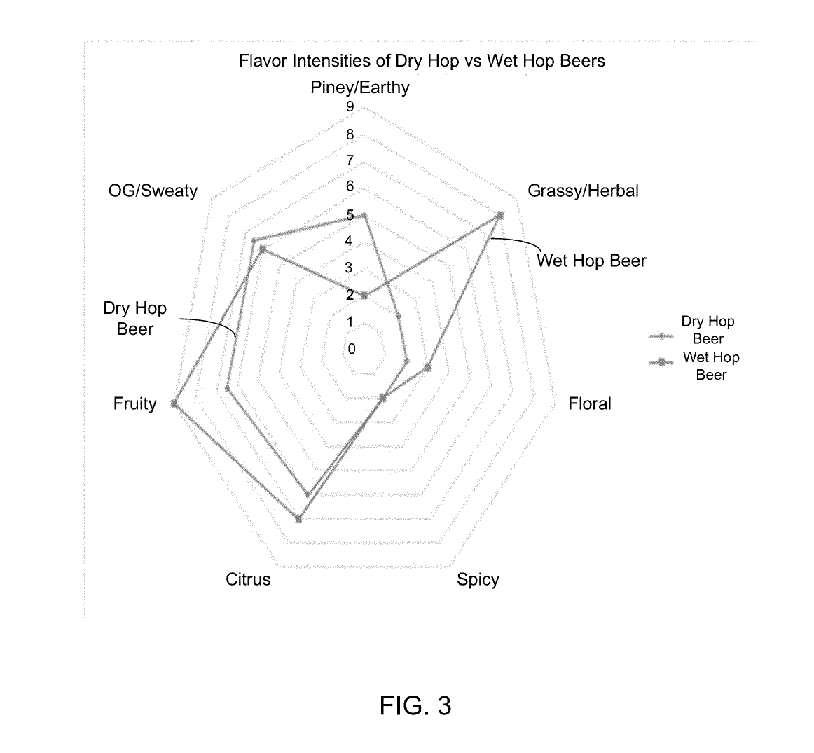

Beer made according to Example 3 (below) was evaluated. The results are shown in FIG. 3. Beer was also made according to Example 4 (below) and the results were not statistically different from those in FIG. 3. These results show that in preferred embodiments beer made from wet hops displays distinct aromas and flavors relative to beer made from dried hops; these wet hop flavors are highly prized and difficult to make at scale. Preferred embodiments of the invention allow for the production of large scale and year round wet hop flavored beer. The data in FIG. 3 was produced by a trained sensory panel of 6 people who smelled and tasted beer samples and wrote down flavor descriptors and scores independently. The panels rated a score of 0-10 based on their assessment of intensity of positive flavor attributes. The data was then collected and averaged to arrive at these scores.

In one embodiment, a hop composition of the invention is frozen to allow for stable storage of the composition. For example, the hop composition is frozen to a temperature of 10° F. (Freezer temperatures typically range from −20° F. to 28° F.) under a blanket of carbon dioxide (or other inert gas) so that any expansion or contraction of the composition will not draw oxygen into the container. Preferred embodiments of the invention can be kept frozen without flavor degradation for up to one year, more than one year, up to three years or more than three years. The slurry can also be kept refrigerated (preferably below 36° F.) for up to 7 days prior to use.

The invention is further illustrated by the following examples, which should not be construed as limiting the invention.

### Example 1—Preparation of Wet Hops Slurry

350 lbs wet hops (75-80% water content) was loaded into a vessel. The pressure was reduced to 0 psi. Carbon dioxide was added up to 4-5 psi. 160 gallons deaerated water was added. The Vortex blender with orbital arm, positive displacement pump, diaphragm pump and shear pump was run until the hop composition was fully processed and of similar consistency (about 15-30 minutes).

### Example 2—Preparation of Frozen Hops Slurry

A sample of the slurry prepared according to Example 1 was placed in a tote. The full tote was pressurized to 5 psi with carbon dioxide and placed in freezer at 10° F. The tote was maintained at 5 psi until the slurry was frozen solid.

### Example 3—Preparation of Beer from Fresh Hops Slurry

A freshly processed slurry prepared according to Example 1 was dosed into a fermentation vessel filled with green beer that still contained active yeast in suspension and not yet cold conditioned. The beer was recirculated for thorough mixing for about 30 minutes.

### Example 4—Preparation of Beer from Frozen Hops Slurry

A tote containing the frozen hops slurry prepared according to Example 2 was removed from frozen storage. The tote was thawed using a tote warmer. 5 psi carbon dioxide was maintained on top of tote to prevent oxygen ingress. The tote was then emptied into a fermentation tank (filled with green beer with active yeast in suspension) using a diaphragm pump with carbon dioxide pressure to make up displaced volume in the tote. The beer was recirculated for thorough mixing for about 30 minutes.

1. A hop composition comprising
1-30 wt % wet hops; and
70-99 wt % added water,
wherein the water of the hop composition contains less than 500 ppb dissolved oxygen.

2. The composition of claim 1, wherein the total solids content is about 15-25%.

3. The composition of claim 1, wherein the composition comprises about 5-25 wt % wet hops, about 10-25 wt % wet hops, about 15-25 wt % wet hops, about 18-23 wt % wet hops, about 19-22 wt % wet hops, or about 20 wt % wet hops.

4. The composition of claim 1, wherein the water of the hop composition contains less than 300 ppb dissolved oxygen, less than 100 ppb dissolved oxygen, less than 50 ppb dissolved oxygen, less than 20 ppb dissolved oxygen, less than 11 ppb dissolved oxygen, or less than 5 ppb dissolved oxygen.

5. The composition of claim 1, wherein the average particle size of the hops is between 5 nm and 5 mm.

6. A method of preparing a hop composition comprising:
admixing between 1-30 wt % wet hops and 70-99 wt % deaerated water under a partial or complete vacuum;
wherein said dearated water contains less than 11 ppb dissolved oxygen,
wherein after admixing under a partial or complete vacuum said hop composition comprises hops and water of the hop composition, and wherein the water of the hop composition contains less than 500 ppb dissolved oxygen, and the average particle size of said hops in said hop composition is between 5 nm and 5 mm.

7. (canceled)

8. The method of claim 6, further comprising using an inert gas to create a partial pressure in said vessel.

9. The method of claim 6, wherein an auger or a vertical blender is used in the admixing of said hop composition.

10. (canceled)

11. The method of claim 6, wherein a shear pump and/or a colloid mill is used to reduce the particle size of said hops in said hop composition.

12. The method of claim 6, further comprising a purification step.

13. The method of claim 12, wherein the purification step comprises identifying and removing solid impurities.

14. A method of using a hop composition in a beer-brewing process comprising:
preparing said hop composition by admixing between 1-30 wt % wet hops and 70-99 wt % deaerated water under partial or complete vacuum,
wherein said dearated water contains less than 11 ppb dissolved oxygen,
wherein after admixing under a partial or complete vacuum said hop composition comprises hops and water of the hop composition, and wherein the water of the hop composition contains less than 500 ppb dissolved oxygen, and the average particle size of the hops in said hop composition is between 5 nm and 5 mm;
optionally freezing said hop composition; and
mixing said hop composition with fermented beer or fermenting wort in said beer-brewing process to prepare a finished beer.

15. (canceled)

16. The method of claim 14, wherein said admixing step comprises using an auger to admix said hop composition.

17. The method of claim 14, further comprising a purification step.

18. The method of claim 17, wherein the purification step comprises identifying and removing solid impurities.

19. The method of claim 14, wherein hop flavors are extracted in the fermented beer or fermenting wort in said beer-brewing process for 1-4 days.

20. The method of claim 14, wherein said finished beer has a yield greater than 80%.
